(19) United States
(12) Patent Application Publication
(10) Pub. No.: US 2024/0311440 A1
(43) Pub. Date: Sep. 19, 2024

(54) OPTIMIZATION APPARATUS, OPTIMIZATION METHOD AND PROGRAM

(71) Applicant: NEC Corporation, Tokyo (JP)

(72) Inventor: Akihiro YATABE, Tokyo (JP)

(73) Assignee: NEC Corporation, Tokyo (JP)

(21) Appl. No.: 18/592,836

(22) Filed: Mar. 1, 2024

(30) Foreign Application Priority Data
Mar. 17, 2023 (JP) 2023-043016

(51) Int. Cl. G06F 17/11

(52) U.S. Cl. CPC G06F 17/11

(57) ABSTRACT

An optimization apparatus provided with at least one memory configured to store instructions; and at least one processor configured to execute the instructions to partition a binary model representing a combinatorial optimization problem to generate binary sub-models. The at least one processor is configured to generate the binary sub-models such that graphs indicating incompatibility constraint conditions of variables in the binary sub-models form connected components, and the incompatibility constraint conditions are constraint conditions indicating that two values that can be taken by the variables cannot simultaneously be one specific value of the two values.

This application is based upon and claims the benefit of priority from Japanese patent application No. 2023-043016, filed Mar. 17, 2023, the disclose of which is incorporated herein in its entirety by reference.

### TECHNICAL FIELD

The present invention relates to an optimization apparatus, an optimization method and a program.

### BACKGROUND ART

A combinatorial optimization problem is a problem with the purpose of selecting, from among numerous options, based on certain indices, the optimal option, which is known as the optimal solution. The options are known to increase exponentially as the number of elements included in a combinatorial optimization problem increase, and when there are too many options, combinatorial optimization problems are difficult to solve. Meanwhile, since combinatorial optimization problems occur in various fields in society, a method for accurately and quickly solving combinatorial optimization problems is sought.

As methods for solving combinatorial optimization problems, methods in which combinatorial optimization problems are expressed in the form of Ising models or QUBO (Quadratic Unconstrained Binary Optimization) models, and the optimal solutions to these models are determined by a type of computer known as an Ising computer based on quantum annealing, simulated annealing, etc. are being extensively developed.

Generally, the scale of combinatorial optimization problems that can be solved by an Ising computer is fixed. The scale of a combinatorial optimization problem is determined by the number of variables used when this problem is represented by an Ising model or a QUBO model, and the maximum number of variables that can be input to each Ising computer is fixed.

Meanwhile, the number of variables required for expressing a combinatorial optimization problem that exists in society with an Ising model, etc. is sometimes greater than the number of variables that can be tolerated by an Ising computer. In such cases, when solving a combinatorial optimization problem, a solution is ensured by reducing the variables required for representing the model, by partitioning the combinatorial optimization problem and converting the problem into a number of sub-problems, etc.

For example, as the method described in Patent Document 1 (JP 2022-159039 A), a method of partitioning a combinatorial optimization problem into sub-problems by solving a set partitioning problem is proposed. In the method described in Patent Document 1, the problem is partitioned so as to reduce the interactions between the sub-problems in the Ising model or the QUBO model.

In the method described in Patent Document 2 (JP 6985481 B), when solving a combinatorial optimization problem with multiple constraint conditions, the constraint conditions are analyzed and partitioned. Patent Document 2 discloses, regarding the analysis of the constraint conditions, that constraint conditions not associated with multiple variables or constraint conditions including fewer variables, among the multiple constraint conditions may be preferred during partitioning. However, aside from task scheduling problems, Patent Document 2 does not explain the specific analysis method for the constraint conditions.
Non-Patent Document 1 (N. Nishimura, K. Tanahashi, K. Suganuma, M. J. Miyama, M. Ohzeki, “Item listing optimization for e-commerce websites based on diversity”, Front. Comput. Sci., 1, 2 (2019)), discloses a method wherein, when extracting sub-problems from an original combinatorial optimization problem, a one-hot constraint condition for selecting one matter from among multiple matters is considered, and variables are extracted so as not to violate the one-hot constraint condition. The one-hot constraint condition is a constraint condition that often occurs when a combinatorial optimization problem is formulated with a binary model such as the QUBO model.

### SUMMARY

An example of an objective of the present disclosure is to provide an optimization apparatus, an optimization method and a program that can more appropriately partition a combinatorial optimization problem that is binary modeled.

According to an example of a first aspect of the present disclosure, an optimization apparatus is provided with at least one memory configured to store instructions; and at least one processor configured to execute the instructions to partition a binary model representing a combinatorial optimization problem to generate binary sub-models; wherein the at least one processor is configured to generate the binary sub-models such that graphs indicating incompatibility constraint conditions of variables in the binary sub-models form connected components, and the incompatibility constraint conditions are constraint conditions indicating that two values that can be taken by the variables cannot simultaneously be one specific value of the two values.

According to an example of a second aspect of the present disclosure, an optimization method is an optimization method by which a binary model representing a combinatorial optimization problem is partitioned to generate binary sub-models. The optimization method includes generating the binary sub-models such that graphs indicating incompatibility constraint conditions of variables in the binary sub-models form connected components, and the incompatibility constraint conditions are constraint conditions indicating that two values that can be taken by the variables are not simultaneously one specific value of the two values.

According to an example of a third aspect of the present disclosure, a non-transitory computer-readable storage medium that stores an optimization program for making a computer execute a process of partitioning a binary model representing a combinatorial optimization problem to generate binary sub-models. The process involves generating the binary sub-models such that graphs indicating incompatibility constraint conditions of variables in the binary sub-models form connected components, and the incompatibility constraint conditions are constraint conditions indicating that two values that can be taken by the variables are not simultaneously one specific value of the two values.

### BRIEF DESCRIPTION OF THE DRAWINGS

FIG. 1 is a diagram illustrating an example of the configuration of an optimization apparatus 1 according to a first embodiment.

FIG. 2 is a matrix (QUBO matrix indicating the first term in Expression (4)) and a graph indicating an example of incompatibility constraint conditions in a QUBO model.

FIG. 3 is a diagram indicating the partitioning of a QUBO model using an example of a matrix indicating incompatibility constraint conditions.

FIG. 4 is a flow chart indicating operations of the optimization apparatus 1 according to the first embodiment.

FIG. 5 is a diagram illustrating an example of the configuration of the optimization apparatus 1 according to a second embodiment.

FIG. 6 is a diagram indicating the partitioning of a QUBO model using an example of a matrix indicating incompatibility constraint conditions.

FIG. 7 is a QUBO matrix of an example of a reconstructed QUBO model.

FIG. 8 is a flow chart indicating operations of the optimization apparatus 1 according to the second embodiment.

FIG. 9 is a schematic block diagram illustrating the configuration of a computer according to at least one embodiment.

### EXAMPLE EMBODIMENT

### First Embodiment

Hereinafter, embodiments of the present disclosure will be explained. However, the embodiments below should not be construed as limiting the disclosure as claimed. Additionally, not all combinations of the features explained in the embodiments are necessarily essential for solving the problem addressed by the disclosure.

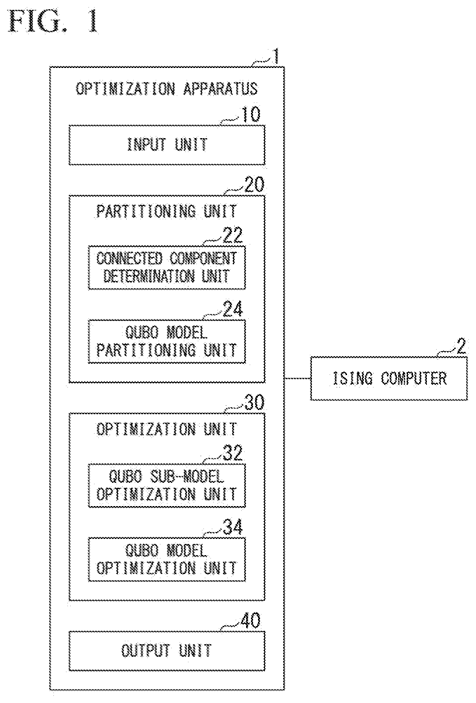

FIG. 1 is a diagram illustrating an example of the configuration of an optimization apparatus 1 according to a first embodiment.

The optimization apparatus 1 is provided with an input unit 10, a partitioning unit 20, an optimization unit 30, and an output unit 40. A binary model is input to the input unit 10. The binary model is a model in which variables may take one of two values.

The binary model is, for example, a QUBO model or an Ising model. The two values that can be taken by the variables in the binary model are not limited to being 0 and 1, and may be different values, or may be different symbols, as long as the two symbols can be differentiated. In the explanation below, a QUBO model in which the variables can take the value of either 0 or 1 will be explained as the binary model. Additionally, binary sub-models generated by partitioning the binary model will be explained by using QUBO sub-models generated by partitioning the QUBO model. Additionally, a reconstructed binary model, which is a binary model in which the variables have been reconstructed, will be explained by using a reconstructed QUBO model, which is a QUBO model in which the variables have been reconstructed.

The partitioning unit 20 partitions the QUBO model into QUBO sub-models, which have fewer variables. The optimization unit 30 optimizes the QUBO model by making calculations with an Ising computer 2 based on the QUBO sub-models. The output unit 40 outputs the results of optimization of the QUBO model. Due to the above, the optimization apparatus 1 calculates the results of optimization of the QUBO model.

Hereinafter, the input unit 10, the partitioning unit 20, and the optimization unit 30 will be explained in detail.

The QUBO model input to the input unit 10 includes constraint conditions for the variables with respect to each other. The constraint conditions are incompatibility constraints, which are constraint conditions that variables cannot be equal to 1 at the same time. Variables that cannot be equal to 1 at the same time are defined as “being incompatible”.

An incompatibility constraint condition is a constraint condition that, among multiple variables, there is zero or one variable that is equal to 1. For example, “x₀=0, x₁=1, x₂=0” and “x₀=0, x₁=0, x₂=0” both satisfy the incompatibility constraint. The incompatibility constraint condition differs from the one-hot constraint condition in that the case in which there are zero variables equal to 1 is not included. That is, “x₀=0, x₁=0, x₂=0” does not satisfy the one-hot constraint condition. The one-hot constraint condition is a constraint condition that is stricter than the incompatibility constraint.

The incompatibility constraint is represented by Expression (1), and is a term in the Hamiltonian of the QUBO model.

$$\begin{matrix}[ Mathematical Expression 1 ] & \\ {\sum }_{( i , j ) ∈ U} {x}_{i} {x}_{j} & ( 1 )\end{matrix}$$

In Expression (1), xᵢ and xⱼ are binary variables that may be equal to 0 or 1. U indicates the set of indices (i and j) of two variables x (xᵢ and xⱼ) that are required to satisfy the incompatibility constraint.

In a QUBO model for solving a set packing problem, an incompatibility constraint condition can be represented by Expression (2), as a Hamiltonian representing a constraint condition for not allowing portions common to the sets Vᵢ, Vⱼ to exist.

$$\begin{matrix}[ Mathematical Expression 2 ] & \\ {\sum }_{i , j : {V}_{i} ⋂ {V}_{j} \neq ϕ} {x}_{i} {x}_{j} & ( 2 )\end{matrix}$$

An incompatibility constraint may alternatively be referred to by using language such as “constraint regarding incompatible elements”, “constraint regarding irreconcilable elements”, “constraint regarding elements that cannot be mutually true”, “constraint regarding mutually exclusive elements”, “mutually exclusive constraint”, “constraint regarding inconsistent elements”, “constraint regarding elements that cannot be mutually true”, “constraints regarding elements that cannot coexist”, “incompatibility constraint”, “inconsistency constraint”, “mutual exclusiveness constraint”, and “repugnance constraint”.

The QUBO matrix includes an objective function for the variables. The objective function is represented as a linear equation by Expression (3).

$$\begin{matrix}[ Mathematical Expression 3 ] & \\ {\sum }_{i ∈ V} {score}_{i} {x}_{i} & ( 3 )\end{matrix}$$

The score; in Expression (3) represents a score corresponding to the variable xᵢ.

The Hamiltonian H of the QUBO model is represented by Expression (4) using Expression (1) and Expression (3).

$$\begin{matrix}[ Mathematical Expression 4 ] & \\ H = C {\sum }_{( i , j ) ∈ U} {x}_{i} {x}_{j} + {\sum }_{i ∈ V} {score}_{i} {x}_{i} & ( 4 )\end{matrix}$$

The QUBO model represented by Expression (4) indicates a problem for determining, among variables for which score information is provided, a combination of variable values that minimizes the Hamiltonian, taking into consideration the incompatibility constraint condition that two specific variables cannot be equal to 1. By setting the value of C in Expression (4) to be large in comparison to scoreᵢ, a combination of variables for which the influence of the Hamiltonian on the incompatibility constraint is large, i.e., which minimizes the objective function by a combination satisfying the incompatibility condition, can be determined.

The input of the QUBO model to the input unit 10 is performed by inputting a matrix normally known as a QUBO matrix. The QUBO model may be input to the input unit 10 by any of the methods below. For example, QUBO matrices indicating the incompatibility constraint conditions of variables and the scores of variables for each of a first term and a second term of the Hamiltonian indicated by Expression (4) may be separately input to the input unit 10. As a result thereof, incompatibility constraint conditions of the variables can be extracted.

Additionally, the input unit 10 may acquire incompatibility constraint conditions of variables input to the Ising computer 2. The Ising computer 2 has incorporated therein, for example, the function of having constraint conditions input thereto and increasing the accuracy of solutions to the combinatorial optimization problem.

Additionally, the input unit 10 may acquire incompatibility constraint conditions for the variables and the scores of the variables by being input to a program for generating QUBO matrices. This is because the program for generating the QUBO matrices may include information on objective functions and constraint conditions for the variables. The program for generating the QUBO matrices is, for example, PyQUBO.

The partitioning unit 20 is provided with a connected component determination unit 22 and a QUBO model partitioning unit 24.

The connected component determination unit 22 determines connected components in a graph, according to graph theory, representing the incompatibility constraint conditions of the QUBO model.

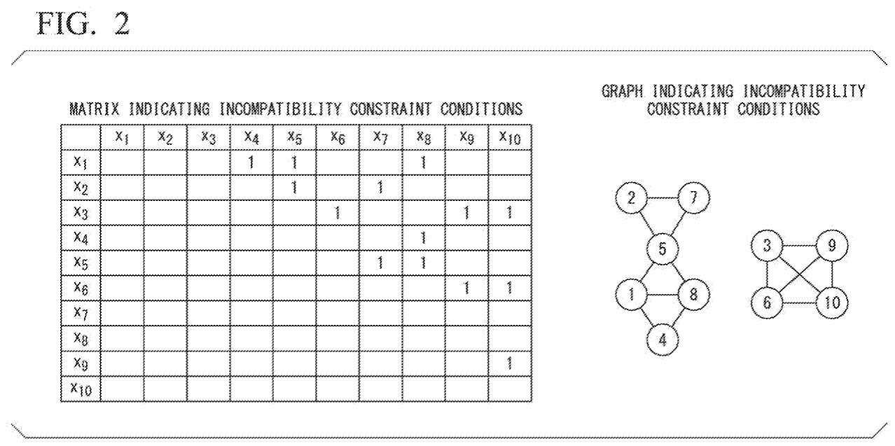

FIG. 2 is a matrix (QUBO matrix indicating the first term of Expression (4)) and a graph indicating an example of incompatibility constraints in a QUBO model. The components of the matrix indicated in FIG. 2 are the components of an upper triangular matrix such that, when the variables xᵢ and xⱼ are incompatible, the value is equal to 1 and the value of all other components is equal to 0. In the example shown in FIG. 2, the variable x₁ is incompatible with x₄, x₅, and x₈, the variable x₂ is incompatible with x₅ and x₇, the variable x₃ is incompatible with x₆, x₉, and x₁₀, the variable x₄ is incompatible with x₈, the variable x₅ is incompatible with x₇ and x₈, the variable x₆ is incompatible with x₉ and x₁₀, and the variable x₉ is incompatible with x₁₀.

The graph shown in FIG. 2 indicates incompatibility constraint conditions. The vertices i in the graph shown in FIG. 2 indicate the variables xᵢ. The edges connecting vertices i with vertices j shown in FIG. 2 indicate that the component is equal to 1 in the matrix indicating incompatibility constraint conditions. In other words, the edges connecting the vertices i with the vertices j shown in FIG. 2 indicate that the variables xᵢ and xⱼ are incompatible.

A connected component is a maximum among connected graphs in which, every vertices included in the graph can be reached to any other vertices included in that graph along edges included in the graph. In the example indicated in FIG. 2, the graph consisting of the vertices 1, 2, 4, 5, 7, and 8 and the graph consisting of the vertices 3, 6, 9, and 10 form connected components. From the above, the connected component determination unit 22 determines connected components.

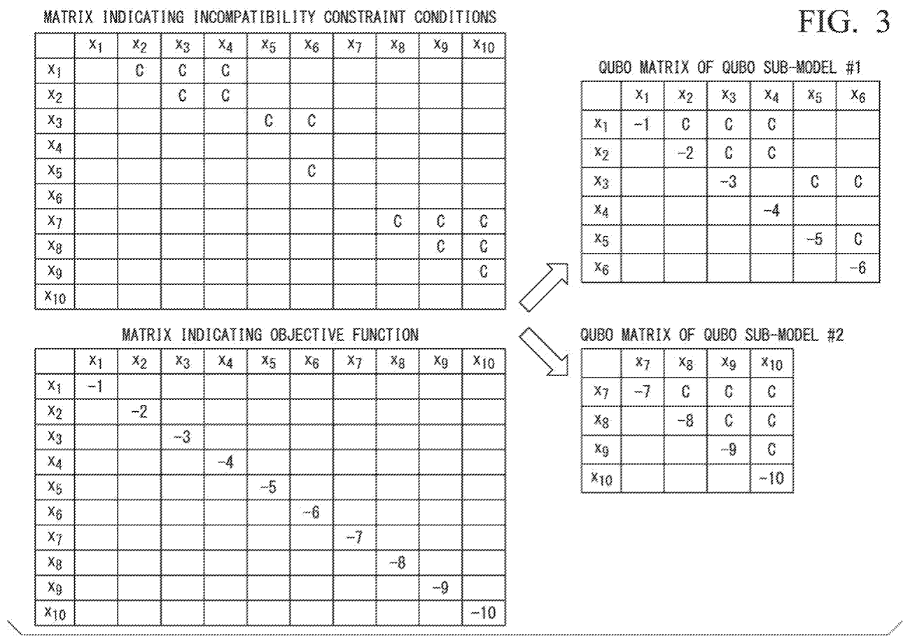

The QUBO model partitioning unit 24 partitions the QUBO model based on the connected components to generate QUBO sub-models including fewer variables. The QUBO model partitioning unit 24 partitions the QUBO model so that the graph indicating the incompatibility constraint conditions for one QUBO sub-model forms a connected component. FIG. 3 is a diagram indicating the partitioning of a QUBO model using matrices indicating an example of incompatibility constraint conditions. In the example indicated in FIG. 3, a QUBO model including ten variables is partitioned to generate a QUBO sub-model #1 including six variables and a QUBO sub-model #2 including four variables.

The partitioning unit 20 may change the indices of the variables during the process of partitioning the QUBO model to generate the QUBO sub-models. For example, the variables shown in FIG. 3 are obtained by changing the variables shown in FIG. 2 from x₂ to x₅, from x₃ to x₇, from x₅ to x₃, from x₆ to x₈, from x₇ to x₆, and from x₈ to x₂. As a result thereof, variables with consecutive indices satisfy the incompatibility constraint conditions and the vertices in the connected components are consecutively numbered. The example indicated in FIG. 3 is the result of having reorganized the indices of the variables.

The optimization unit 30 is provided with a QUBO sub-model optimization unit 32 and a QUBO model optimization unit 34.

The QUBO sub-model optimization unit 32 calculates combinations of solutions to the variables that optimize for each QUBO sub-model, by outputting QUBO sub-models to the Ising computer 2. In the example shown in FIG. 3, a combination of solutions in which x₄=x₆=1 and all other variables are equal to 0 is calculated from QUBO sub-model #1. Additionally, a combination of solutions in which x₁₀=1 and all other variables are equal to 0 is calculated from QUBO sub-model #2.

The QUBO model optimization unit 34 calculates a combination of solutions to the variables that optimize the QUBO model based on the combinations of optimizing variables calculated for each QUBO sub-model. In the first embodiment, there are no variables that are common to both QUBO sub-models. Thus, the combination of solutions to the variables calculated by the QUBO model optimization unit 34 may be a collection of the combinations of solutions to the variables optimizing for each QUBO sub-model. In the example indicated in FIG. 3, the combination of solutions to the variables in the QUBO model is the solution in which x₄=x₆=x₁₀=1, and all other variables are equal to 0.

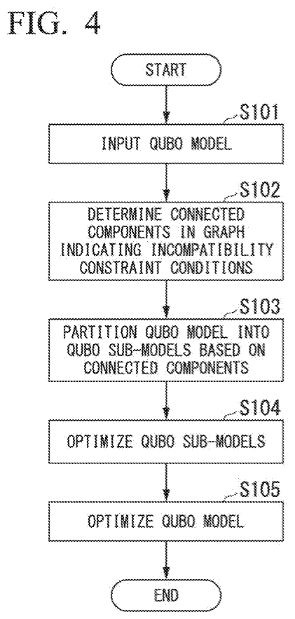

FIG. 4 is a flow chart indicating the operations of the optimization apparatus 1 according to the first embodiment. First, a QUBO model is input to the input unit 10 (step S101). Then, the connected component determination unit 22 determines connected components in a graph indicating the incompatibility constraint conditions of variables in the QUBO model (step S102). The QUBO model partitioning unit 24 partitions the QUBO model based on the connected components to prepare QUBO sub-models including fewer variables (step S103). Then, the QUBO sub-model optimization unit 32 calculates the combinations of solutions to the variables optimizing each QUBO sub-model (step S104). The QUBO model optimization unit 34 calculates the combination of solutions to the variables optimizing the QUBO model based on the combinations of optimizing variables calculated for each QUBO sub-model (step S105).

Thus, the optimization apparatus 1 according to the first embodiment partitions the QUBO model into QUBO sub-models with fewer variables based on connected components in a graph indicating incompatibility constraint conditions on the variables. Since there are no variables that are common to the QUBO sub-models, the QUBO sub-models can be optimized independently of other QUBO sub-models. As a result thereof, the optimization apparatus 1 according to the first embodiment can more appropriately partition combinatorial optimization problems that have been expressed in the form of QUBO models.

### Second Embodiment

An objective function in a QUBO model in a second embodiment is linear or quadratic.

An objective function that is quadratic can be represented by Expression (5).

$$\begin{matrix}[ Mathematical Expression 5 ] & \\ {\sum }_{i ∈ V} {h}_{i} {x}_{i} + {\sum }_{i , j ∈ V} {Q}_{i , j} {x}_{i} {x}_{j} & ( 5 )\end{matrix}$$

In Expression (5), h; is the score of the variable xᵢ, and Q_{i,j} is the score of the combination of the variables xᵢ and xⱼ.

In the case in which the objective function is quadratic, the Hamiltonian H of the QUBO model is represented by Expression (6), using Expression (1) and Expression (5).

$$\begin{matrix}[ Mathematical Expression 6 ] & \\ H = C {\sum }_{( i , j ) ∈ U} {x}_{i} {x}_{j} + {\sum }_{i ∈ V} {h}_{i} {x}_{i} + {\sum }_{i , j ∈ V} {Q}_{i , j} {x}_{i} {x}_{j} & ( 6 )\end{matrix}$$

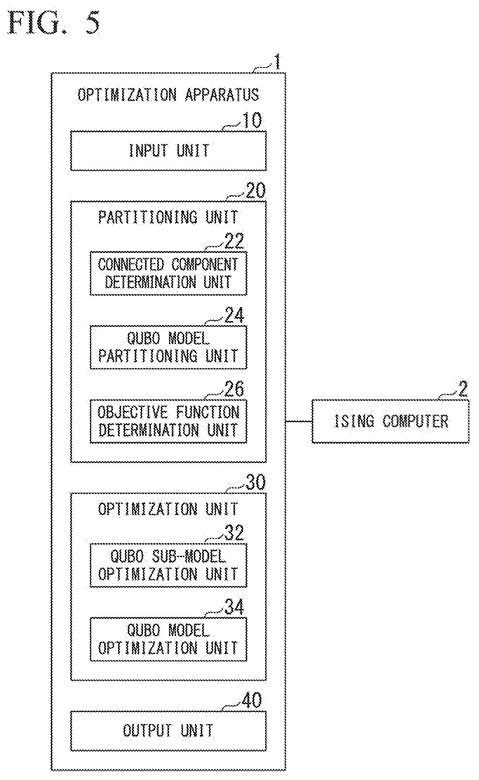

FIG. 5 is a diagram indicating an example of the configuration of the optimization apparatus 1 according to a second embodiment.

The partitioning unit 20 according to the second embodiment is provided with an objective function determination unit 26 in addition to the partitioning unit 20 according to the first embodiment. Additionally, the QUBO model optimization unit 34 according to the second embodiment optimizes the QUBO model by a method different from the QUBO model optimization unit 34 according to the first embodiment based on the determination results by the objective function determination unit 26.

The objective function determination unit 26 determines whether or not the objective function is quadratic and the variables x are shared by connected components. A variable x being shared by connected components means that Q_{i,j} in Expression (5) is non-zero, and that the two variables xᵢ and xⱼ appear in different connected components. In the case in which the objective function is quadratic and there is at least one variable x shared by connected components, there is a problem in that there are variables common to different QUBO sub-models when partitioning the QUBO model in the first embodiment.

When the objective function is linear or there is not a single variable x shared by the connected components, the optimization unit 30 optimizes the QUBO model by a method similar to that in the first embodiment. In other words, when the objective function is linear or there are no variables x shared by the connected components, the QUBO model partitioning unit 24 partitions the QUBO model to generate QUBO sub-models, the QUBO sub-model optimization unit 32 optimizes the QUBO sub-models, and the QUBO model optimization unit 34 optimizes the QUBO model based on the optimal solutions to the QUBO sub-models. When the objective function is linear or there are no variables x shared by the connected components, since the variables will not be shared between QUBO sub-models, the QUBO model can be optimized by a method similar to that in the first embodiment.

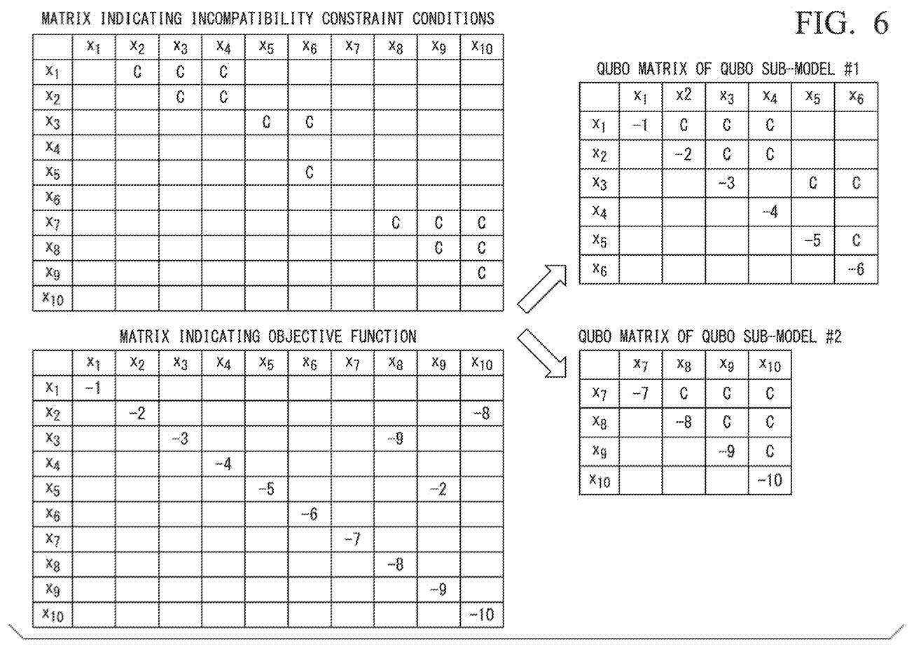

Even when the objective function is quadratic and there is at least one variable x shared by the connected components, the QUBO model partitioning unit 24 first partitions the QUBO model based on the connected components to prepare QUBO sub-models. FIG. 6 is a diagram indicating the partitioning of a QUBO model using an example of a matrix indicating incompatibility constraint conditions. FIG. 6 shows a matrix indicating the incompatibility constraint conditions (the first term in Expression (6)) and a matrix indicating the objective function (the second term and the third term in Expression (6)). The matrix indicating the incompatibility constraint conditions shown in FIG. 6 is the same as the matrix indicating the incompatibility constraint conditions indicated in FIG. 3, i.e., the connected components are the same. In the example indicated in FIG. 6, the QUBO model partitioning unit 24 first partitions the QUBO model to prepare QUBO sub-model #1 including the variables x₁ to x₆ and QUBO sub-model #2 including the variables x₇ to x₁₀.

Thereafter, the QUBO sub-model optimization unit 32 optimizes the QUBO sub-models by using only the linear term in the objective function. In the example shown in FIG. 6, the linear term in the objective function is the same as the objective function shown in FIG. 3 (when using Expression (4) and Expression (6), scoreᵢ=hᵢ (where i=1 to 10)). For this reason, the QUBO sub-model optimization unit 32 calculates, from QUBO sub-model #1, the combination of solutions in which x₄=x₆=1 and all other variables are equal to 0. Additionally, the QUBO sub-model optimization unit 32 calculates, from QUBO sub-model #2, the combination of solutions in which x₁₀=1 and all other variables are equal to 0.

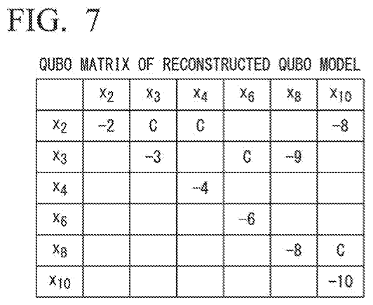

The QUBO model optimization unit 34 reconstructs the QUBO model based on the variables that are equal to 1 in the optimization of the QUBO sub-models, and the variables in the quadratic term in the objective function for which the absolute values of the coefficients are large. In the example indicated in FIG. 6, the QUBO model optimization unit 34 includes x₄, x₆, and x₁₀, which are the variables that were equal to 1 in the optimization of the QUBO sub-models, in the QUBO model to be reconstructed (reconstructed QUBO model). Additionally, the QUBO model optimization unit 34 includes, in the reconstructed QUBO model, x₃ and x₈, for which the absolute values of the coefficients are the largest, and x₂, for which the absolute value of the coefficient is the next largest (x₁₀ is already included). FIG. 7 is a QUBO matrix for an example of a reconstructed QUBO model.

The number of variables included in a reconstructed QUBO model may be determined arbitrarily. For example, the number of variables is determined by the number of variables allowed by the Ising computer 2. In the above explanation using FIG. 6, the number of variables included in the reconstructed QUBO model was six. However, it may be another number.

Among the variables included in the reconstructed QUBO model, the variables that were equal to 1 in the optimization of the QUBO sub-models are prioritized. The QUBO model optimization unit 34 first determines the variables that were equal to 1 in the optimization of the QUBO sub-model to be the variables to be included in the QUBO model to be reconstructed. Thereafter, the QUBO model optimization unit 34 determines the variables in the order of the sizes of the absolute values of the coefficients in the quadratic term in the objective function up to the number of variables that can be included in the QUBO model to be reconstructed. When determining the variables included in the QUBO model to be reconstructed, there may be cases in which the number of variables that can next be included in the QUBO model to be reconstructed is one variable, yet the variable with the coefficient in the quadratic term of the objective function including the next largest absolute value is not yet included in the QUBO model, i.e., a case arise in which two new variables are required to be included. At this time, either of the two variables, or neither one, may be included in the QUBO model to be reconstructed.

The QUBO model optimization unit 34 optimizes the reconstructed QUBO model. The method of optimization is similar to the method for optimization of the QUBO sub-models by the QUBO sub-model optimization unit 32. The examples shown in FIG. 7 are matrices of an objective function and the incompatibility constraint conditions in a QUBO model including the variables x₄, x₆, x₁₀, x₃, x₈, and x₂. The output unit 40 outputs, as the optimal solution to the QUBO model input to the input unit 10, the solution obtained by optimizing the reconstructed QUBO model.

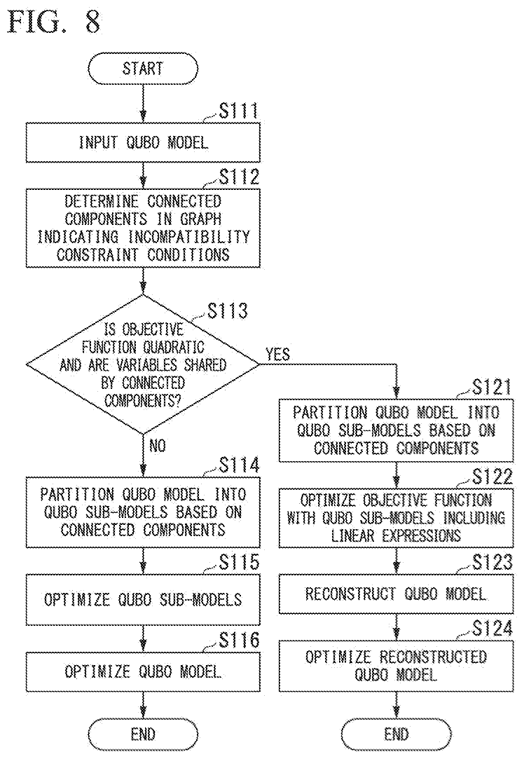

FIG. 8 is a flow chart indicating the operations of the optimization apparatus 1 according to the second embodiment. First, a QUBO model is input to the input unit 10 (step S111). Then, the connected component determination unit 22 determines connected components in the graph indicating the incompatibility constraint conditions of variables in the QUBO model (step S112). The objective function determination unit 26 determines whether the objective function is quadratic and there are variables x shared by the connected components (step S113). In the case in which the objective function is linear or there are no variables x shared by the connected components (step S113: YES), the QUBO model partitioning unit 24 partitions the QUBO model based on the connected components to prepare QUBO sub-models including fewer variables (step S114). Then, the QUBO sub-model optimization unit 32 calculates the combinations of solutions to the variables optimizing for each QUBO sub-model (step S115). The QUBO model optimization unit 34 calculates the combination of solutions to the variables optimizing the QUBO model based on the combinations of optimizing variables calculated for each QUBO sub-model (step S116). The operations in step S114 to step S116 are the same as those in steps S103 to S105 in the flow chart indicated in FIG. 4.

In the case in which the objective function is linear and there is at least one variable x shared by the connected components (step S113: YES), the QUBO model partitioning unit 24 partitions the QUBO model based on the connected components to prepare QUBO sub-models including fewer variables (step S121). The QUBO sub-model optimization unit 32 uses only the linear term in the objective function to optimize the QUBO sub-models (step S122). The QUBO model optimization unit 34 reconstructs the QUBO model and generates the reconstructed QUBO model (step S123). The QUBO model optimization unit 34 optimizes the reconstructed QUBO model (step S124).

The variables that were equal to 1 in the optimization of the QUBO sub-models are the variables that are highly likely to have a value equal to 1 even when taking into consideration quadratic terms shared by connected components. The variables for which the absolute values of the coefficients in the objective function are large are also highly likely to have values equal to 1. In the second embodiment, the QUBO model optimization unit 34 reconstructs the QUBO model based on the variables that were equal to 1 in the optimization of the QUBO sub-models and the variables in the quadratic term of the objective function for which the absolute values of the coefficients are large, thereby optimizing the reconstructed QUBO model. For this reason, an excellent solution to the QUBO model can be calculated even in the case in which the objective function includes a quadratic term.

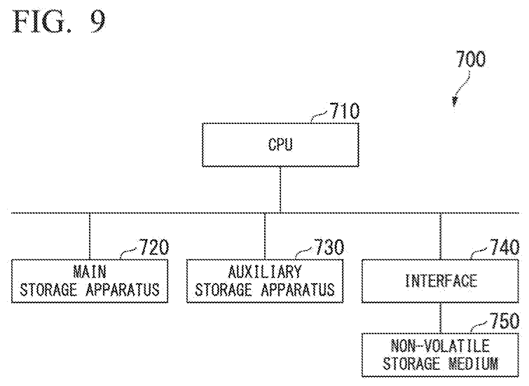

FIG. 9 is a schematic block diagram indicating the configuration of a computer according to at least one embodiment.

In the configuration indicated in FIG. 9, the computer 700 is provided with a CPU 710, a main storage apparatus 720, an auxiliary storage apparatus 730, an interface 740, and a non-volatile recording medium 750.

The above-mentioned optimization apparatus 1 or a portion thereof may be implemented in the computer 700. In that case, the operations of the respective processing units mentioned above are stored in the auxiliary storage apparatus 730 in the form of programs.

The CPU 710 reads the programs from the auxiliary storage apparatus 730, loads them in the main storage apparatus 720, and executes the above-mentioned processes in accordance with said programs. Additionally, the CPU 710 secures, in the main storage apparatus 720, storage areas corresponding to the respective storage units mentioned above in accordance with the programs. The communication between the respective apparatuses and other apparatuses is executed by the interface 740 including a communication function and communicating in accordance with control by the CPU 710. Additionally, the interface 740 has a port for the non-volatile recording medium 750, reads information from the non-volatile recording medium 750 and writes information into the non-volatile recording medium 750.

When the optimization apparatus 1 is implemented on the computer 700, the operations of the optimization apparatus 1 and the respective units thereof are stored in the auxiliary storage apparatus 730 in the form of programs. The CPU 710 reads the programs from the auxiliary storage apparatus 730, loads them in the main storage apparatus 720, and executes the above-mentioned processes in accordance with said programs.

Additionally, the CPU 710 secures, in the main storage apparatus 720, storage areas for the input unit 10 in accordance with the programs. The communication between the respective units in the optimization apparatus 1 is executed by the interface 740 including a communication function and being operated in accordance with control by the CPU 710. The displaying of results output by the output unit 40 is executed by the interface 740 being provided with a display apparatus and displaying the results in accordance with control by the CPU 710. Inputs to the input unit 10 are executed by the interface 740 being provided with an input device and receiving user operations in accordance with control by the CPU 710.

When the optimization apparatus 1 is implemented on the computer 700, the operations of the partitioning unit 20 and the optimization unit 30 are stored in the auxiliary storage apparatus 730 in the form of programs. The CPU 710 reads the programs from the auxiliary storage apparatus 730, loads them in the main storage apparatus 720, and executes the above-mentioned processes in accordance with said programs.

Additionally, the CPU 710 secures, in the main storage apparatus 720, storage areas for the optimization apparatus 1 to perform processes in accordance with the programs. The communication between the respective apparatuses in the optimization apparatus 1 is executed by the interface 740 including a communication function and being operated in accordance with control by the CPU 710. Interactions between the optimization apparatus 1 and a user are executed by the interface 740 including an input device and an output device, presenting information to the user on the output device in accordance with control by the CPU 710, and receiving user operations on the input device.

Any one or more of the above-mentioned programs may be recorded on the non-volatile recording medium 750. In that case, the interface 740 may read the programs from the non-volatile recording medium 750. Then, the CPU 710 may directly execute the programs read by the interface 740, or may execute them by temporarily storing them in the main storage apparatus 720 or the auxiliary storage apparatus 730.

Programs for executing some or all of the processes performed by the optimization apparatus 1 may be recorded on a computer-readable recording medium, and the programs recorded on this recording medium may be read into a computer system and executed in order to perform the processes of the respective units. The “computer system” mentioned here includes an OS (operating system) and hardware such as peripheral devices.

Additionally, the “computer-readable recording medium” refers to a portable medium such as a flexible disk, a magneto-optic disk, a ROM (read-only memory), or a CD-ROM (compact disc read-only memory), or to a storage apparatus, such as a hard disk, inside a computer system. Additionally, the above-mentioned programs may be for realizing just some of the aforementioned functions, and may further be able to realize the aforementioned functions by being combined with a program already recorded in a computer system.

Thus, according to the present disclosure, a combinatorial optimization problem that is expressed in the form of a binary model can be more appropriately partitioned.

While embodiments of the present disclosure have been described in detail with reference to the drawings above, the specific configurations are not limited to these embodiments, and designs, etc. within a range not departing from the spirit of this disclosure are also included.

While preferred embodiments of the disclosure have been described and illustrated above, it should be understood that these are exemplary of the disclosure and are not to be considered as limiting. Additions, omissions, substitutions, and other modifications can be made without departing from the spirit or scope of the present disclosure. Accordingly, the disclosure is not to be considered as being limited by the foregoing description, and is only limited by the scope of the appended claims.

Some or all of the embodiments described above may be described by, but are not limited to, the following supplementary notes.

### (Supplementary Note 1)

An optimization apparatus comprising partitioning means for partitioning a binary model representing a combinatorial optimization problem to generate binary sub-models; wherein the partitioning means generates the binary sub-models such that graphs indicating incompatibility constraint conditions of variables in the binary sub-models form connected components, and the incompatibility constraint conditions are constraint conditions indicating that two values that can be taken by the variables cannot simultaneously be one specific value of the two values.

### (Supplementary Note 2)

The optimization apparatus according to Supplementary note 1, further comprising optimizing means for optimizing the binary sub-models and for optimizing the binary model based on optimization results of the binary sub-models.

### (Supplementary Note 3)

The optimization apparatus according to Supplementary note 2, wherein the optimizing means generates a reconstructed binary model in which the variables are reconstructed when an objective function of the binary model is quadratic and variables are shared by the connected components, and the binary model is optimized by optimizing the reconstructed binary model.

### (Supplementary Note 4)

The optimization apparatus according to Supplementary note 3, wherein the optimizing means determines a variable included in the reconstructed binary model to be a variable having a value that is the one specific value when considering only a linear equation in the objective function.

### (Supplementary Note 5)

The optimization apparatus according to Supplementary note 4, wherein the optimizing means determines variables to be included in the reconstructed binary model in the order of variables for which absolute values of coefficients of quadratic terms in the objective function are larger.

### (Supplementary Note 6)

An optimization method by which a computer partitions a binary model representing a combinatorial optimization problem to generate binary sub-models, wherein the optimization method includes generating the binary sub-models such that graphs indicating incompatibility constraint conditions of variables in the binary sub-models form connected components, and the incompatibility constraint conditions are constraint conditions indicating that two values that can be taken by the variables are not simultaneously one specific value of the two values.

### (Supplementary Note 7)

The optimization method according to Supplementary note 6, further comprising optimizing the binary sub-models and for optimizing the binary model based on optimization results of the binary sub-models.

### (Supplementary Note 8)

The optimization method according to Supplementary note 7, wherein the optimizing includes generating a reconstructed binary model in which the variables are reconstructed when an objective function of the binary model is quadratic and variables are shared by the connected components, and the binary model is optimized by optimizing the reconstructed binary model.

### (Supplementary Note 9)

The optimization method according to Supplementary note 8, wherein the optimizing includes determining a variable included in the reconstructed binary model to be a variable having a value that is the one specific value when considering only a linear equation in the objective function.

### (Supplementary Note 10)

The optimization method according to Supplementary note 9, wherein the optimizing includes determining variables to be included in the reconstructed binary model in the order of variables for which absolute values of coefficients of quadratic terms in the objective function are larger.

### (Supplementary Note 11)

An optimization program for making a computer execute a process of partitioning a binary model representing a combinatorial optimization problem to generate binary sub-models, wherein the process involves generating the binary sub-models such that graphs indicating incompatibility constraint conditions of variables in the binary sub-models form connected components, and the incompatibility constraint conditions are constraint conditions indicating that two values that can be taken by the variables are not simultaneously one specific value of the two values.

What is claimed is:

1. An optimization apparatus comprising:
at least one memory configured to store instructions; and
at least one processor configured to execute the instructions to:
partition a binary model representing a combinatorial optimization problem to generate binary sub-models;
wherein
the at least one processor is configured to generate the binary sub-models such that graphs indicating incompatibility constraint conditions of variables in the binary sub-models form connected components, and
the incompatibility constraint conditions are constraint conditions indicating that two values that can be taken by the variables cannot simultaneously be one specific value of the two values.

2. The optimization apparatus according to claim 1,
wherein the at least one processor is further configured to optimize the binary sub-models and for optimizing the binary model based on optimization results of the binary sub-models.

3. The optimization apparatus according to claim 2, wherein
the at least one processor is configured to generate a reconstructed binary model in which the variables are reconstructed when an objective function of the binary model is quadratic and variables are shared by the connected components, and
the binary model is optimized by optimizing the reconstructed binary model.

4. The optimization apparatus according to claim 3, wherein
the at least one processor is further configured to determine a variable included in the reconstructed binary model to be a variable having a value that is the one specific value when considering only a linear equation in the objective function.

5. The optimization apparatus according to claim 4, wherein
the at least one processor is further configured to determine variables to be included in the reconstructed binary model in the order of variables for which absolute values of coefficients of quadratic terms in the objective function are larger.

6. An optimization method by which a computer partitions a binary model representing a combinatorial optimization problem to generate binary sub-models,
the optimization method comprising:
generating the binary sub-models such that graphs indicating incompatibility constraint conditions of variables in the binary sub-models form connected components, and
the incompatibility constraint conditions are constraint conditions indicating that two values that can be taken by the variables are not simultaneously one specific value of the two values.

7. The optimization method according to claim 6, further comprising:
optimizing the binary sub-models and for optimizing the binary model based on optimization results of the binary sub-models.

8. The optimization method according to claim 7, wherein
the optimizing includes generating a reconstructed binary model in which the variables are reconstructed when an objective function of the binary model is quadratic and variables are shared by the connected components, and
the binary model is optimized by optimizing the reconstructed binary model.

9. The optimization method according to claim 8, wherein
the optimizing includes determining a variable included in the reconstructed binary model to be a variable having a value that is the one specific value when considering only a linear equation in the objective function.

10. The optimization method according to claim 9, wherein
the optimizing includes determining variables to be included in the reconstructed binary model in the order of variables for which absolute values of coefficients of quadratic terms in the objective function are larger.

11. A non-transitory computer-readable storage medium that stores an optimization program for making a computer execute a process of partitioning a binary model representing a combinatorial optimization problem to generate binary sub-models,
the process comprising:
generating the binary sub-models such that graphs indicating incompatibility constraint conditions of variables in the binary sub-models form connected components, and
the incompatibility constraint conditions are constraint conditions indicating that two values that can be taken by the variables are not simultaneously one specific value of the two values.
